(19) United States
(12) Patent Application Publication
(10) Pub. No.: US 2002/0043380 A1
(43) Pub. Date: Apr. 18, 2002

(54) Weed extractor

(76) Inventors: Barbara P. Rountree, Plano, TX (US); Robert N. Rountree, Plano, TX (US)

Correspondence Address: ROBERT N. ROUNTREE, 3816 Kimbrough Lane, Plano, TX, 75025, US

(21) Appl. No.: 09/840,502

(22) Filed: Apr. 23, 2001

Related U.S. Application Data
(60) Provisional application No. 60/198,937, filed on Apr. 21, 2000.

(51) Int. Cl. A01B 1/00

(52) U.S. Cl. 172/378

(57) ABSTRACT

A weed extractor is designed with a first shaft (302) having a handle end and a distal end and a second shaft (300) having a handle end and a distal end. A bit assembly has an upper alignment device (202) connected to the distal end of the first shaft and a lower alignment device (208) connected to the distal end of the second shaft. A latch (306) is connected between the handle end of the first shaft and the handle end of the second shaft. The latch has a first position permitting the bit assembly to move between an open position and a closed position and a second position arranged to hold the bit assembly in the closed position.

### CLAIM TO PRIORITY OF PROVISIONAL APPLICATION

This application claims priority under 35 U.S.C. § 119(e)(1) of provisional application number 60/198,937, filed Apr. 21, 2000.

### FIELD OF THE INVENTION

This invention relates to lawn and garden tools and more particularly to a manual plant or weed extractor.

### BACKGROUND OF THE INVENTION

Weeds affect many lawns at some time. A use of chemical means to control these weeds, however, may damage or destroy the existing lawn. Although most broadleaf weeds are easily eliminated from lawns by treatment with commercially available broadleaf weed killer, grassy weeds are much more difficult to remove. Annual grassy weeds such as crabgrass, grassburs and winter grasses may be controlled by application of pre-emergent weed killers in late winter and again in late spring without damage to existing lawns. Perennial grassy weeds such as dallisgrass and johnsongrass may be controlled in bermuda lawns by careful and repeated application of MSMA or DSMA in late spring or early summer. Most treatments for perennial grassy weeds in St. Augustine lawns, however, are ineffective. Although spot treatment with MSMA, DSMA or glyphosate may kill the weeds, it will also kill large patches of the St. Augustine lawn.

Many weed pullers have been developed to remove weeds from lawns or gardens where chemical means are ineffective. Some of these weed pullers have jaws or blades that pinch or grab the upper part of the weed and attempt to pull it from the soil. These weed pullers may be effective against individual weeds in-sandy or loamy soil. They are ineffective, however, in dense soil such as clay against weeds with extensive root systems such as dallisgrass and johnsongrass. Often the grasping action of the jaws or blades damages a weed so that a subsequent attempt to pull the weed simply results in decapitation. Alternatively, the weed pullers with prongs or spikes may not effectively grab the weed and lose a grip on the weed during the attempted extraction. Another problem with pronged or forked weed pullers arises due to the space between the prongs or forks. When extraction of weed groups is attempted, the prongs or forks may separate the weed into many small sections that slip between the prongs or forks and remain firmly rooted in the ground. Yet another problem with these weed pullers is that they require the user to constantly bend and lift to extract the weed from the ground. Rotary weed pullers present yet another problem. They twist the top of the weed with respect to the weed's root system and may decapitate the weed leaving much of the root system in the ground. A further problem with many of these weed pullers is due to ineffective leverage provided for extraction even if the weed is properly grasped. Thus, repeated use is often difficult and exhausting work.

Referring now to FIG. 1, there is a weed extractor of the prior art as described in U.S. Pat. No. 6,016,876, issued Jan. 25, 2000, and incorporated herein by reference. The weed extractor includes an elongated shaft 100 having a handle end 124. A bit assembly 118 is attached to the distal end of the elongated shaft. A handle piece 102 is pivotally mounted on elongated shaft 100 by pin 104. Control piece 106 is pivotally attached to handle piece 102 and detent piece 130. Detent piece 130 is pivotally mounted to upright member 122 by pin 134. Detent piece 130 is moved to a first position by spring 132. Detent piece 130 is moved to a second position via control member 106 in response to a force applied to handle piece 102. A foot piece 116, having extended tabs 200, is slidely attached at a first end to the elongated shaft by pin 120. The foot piece extends laterally from the elongated shaft. The foot piece is held in this lateral position by upright member 122, having tabs 108. The upright member 122 and tabs 108 are slidely attached to the elongated shaft by pin 110. Diagonal member 112 accomplishes triangulation between the foot piece and the upright piece 122. Fulcrum piece 114 is centrally attached to a second end of foot piece 116 and to diagonal member 112 so that fulcrum piece 114 is perpendicular to foot piece 116.

Although the weed extractor of FIG. 1 effectively extracts large weeds with minimal damage to the top or root system, it requires several moving parts including the control piece, handle piece, foot piece and spring. These parts increase complexity, weight and manufacturing cost. Furthermore, a bit assembly designed for one type of weed may not be an optimal size for another type of weed. Thus, a large bit assembly may extract more surrounding dirt than necessary when extracting small weeds.

### SUMMARY OF THE INVENTION

These problems are resolved by a weed extractor, comprising a first shaft having a handle end and a distal end and a second shaft having a handle end and a distal end. A bit assembly has an upper alignment device connected to the distal end of the first shaft and a lower alignment device connected to the distal end of the second shaft. A latch is connected between the handle end of the first shaft and the handle end of the second shaft. The latch has a first position permitting the bit assembly to move between an open position and a closed position and a second position arranged to hold the bit assembly in the closed position.

The present invention captures the weed when the bit assembly moves from the open position to the closed position. Operation is greatly simplified compared to weed extractors of the prior art. The opposed spikes close under the weed to minimize damage to the weed prior to extraction.

### BRIEF DESCRIPTION OF THE DRAWINGS

A more complete understanding of the invention may be gained by reading the subsequent detailed description with reference to the drawings wherein:

FIG. 1 is a perspective view of an embodiment of a weed extractor of the prior art;

FIG. 2A is a front view of a bit assembly of the present invention in an open position;

FIG. 2B is a front view of the bit assembly of the present invention in a closed position;

FIG. 3 is a side view of an embodiment of the present invention with the bit assembly in the closed position;

FIG. 4A is a side view of the handle and latching mechanism of the embodiment of FIG. 3 of the present invention with the bit assembly in the closed position;

FIG. 4B is a side view of the embodiment of FIG. 4A of the present invention with the bit assembly in the open position;

FIG. 5A is a side view of another embodiment of the handle and latching mechanism of the present invention with the bit assembly in the closed position;

FIG. 5B is a side view of the embodiment of FIG. 5A of the present invention with the bit assembly in the open position;

FIG. 6 is a side view of another embodiment of the weed extractor of the present invention with the bit assembly in the closed position;

FIG. 7A is a front view of another embodiment of the weed extractor of the present invention having a removable bit assembly; and

FIG. 7B is a front view of yet another embodiment of the weed extractor of the present invention having removable spikes.

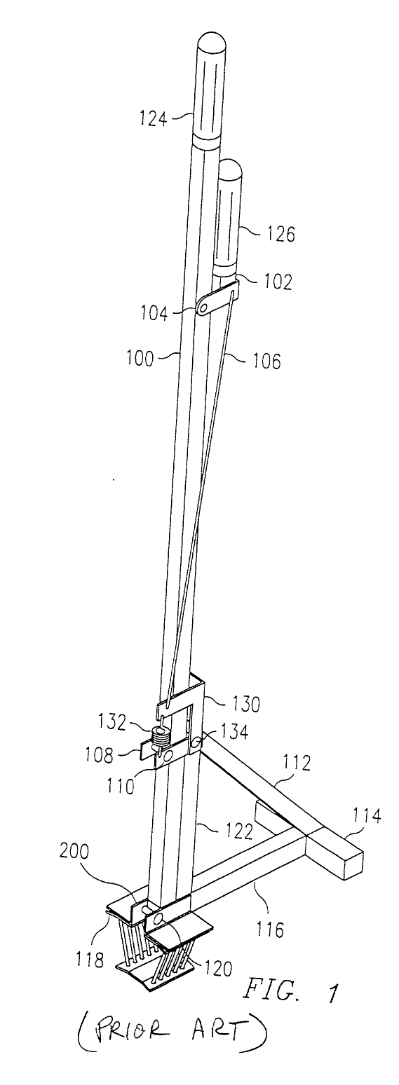

### DETAILED DESCRIPTION OF THE PREFERRED EMBODIMENTS

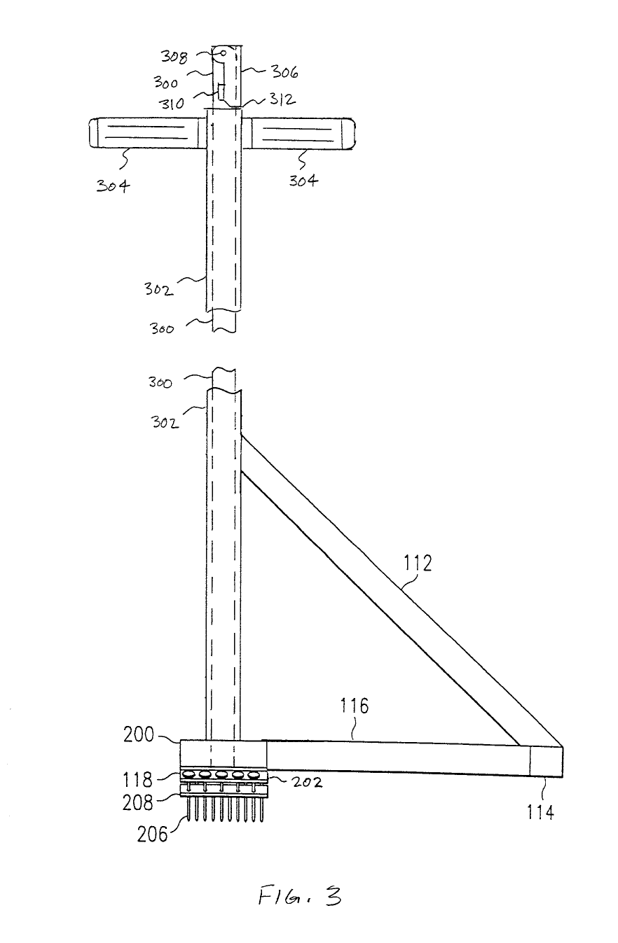

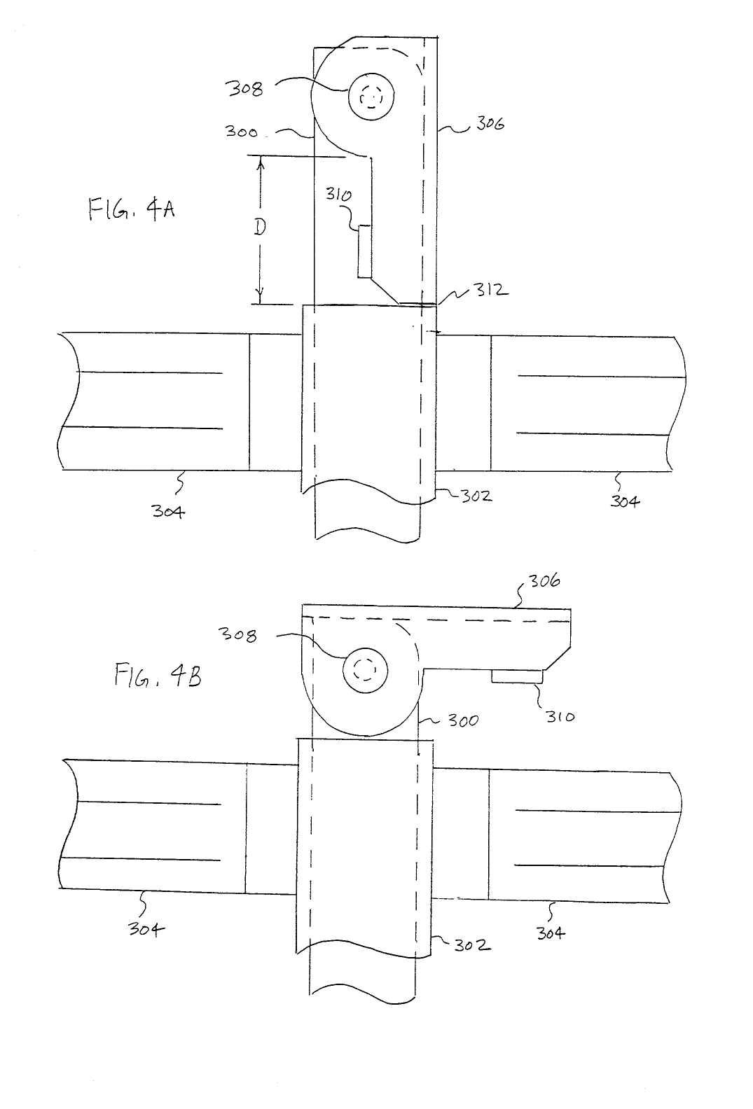

Referring now to FIG. 3, an embodiment of a weed extractor of the present invention will be described in detail. The weed extractor includes a first elongated shaft 302 having a handle end at handles 304 and a distal end connected to an upper alignment device 202 at bit assembly 118. A second elongated shaft 300 has a common axis with the first shaft. The second shaft has a handle end and a distal end connected to a lower alignment device 208. The first and second shafts are preferably made from square tubing to maintain rotational alignment with respect to their common axis. Handles 304 are attached to the handle end of the first shaft 302 to facilitate control of the extractor. A latch 306 is pivotally attached by hinge pin 308 to the handle end of the second shaft 300. In a first position, the latch permits the first shaft to move with respect to the second shaft as will be explained in detail. This movement of the first shaft with respect to the second shaft permits the bit assembly to move between an open position and a closed position. In a second position as shown, the latch 306 abuts the handle end of the first shaft 302 at 312, thereby holding the first shaft in fixed relation to the second shaft. This fixed relation holds the bit assembly 118 in a closed position. The latch 306 further includes control tab 310 to facilitate movement of the latch between the first and second positions. A foot piece 116, having extended tabs 200, is attached to the distal end of the first shaft 302. The foot piece extends laterally from the first shaft. Triangulation between the foot piece and the first shaft 302 is accomplished by diagonal member 112. Fulcrum piece 114 is centrally attached to a second end of foot piece 116 and to diagonal member 112 so that fulcrum piece 114 is perpendicular to foot piece 116.

Attachment of foot piece 116 to the first shaft and triangulation by diagonal member 112 is highly advantageous in providing a rigid foot piece for operating the bit assembly from an open position to a closed position even in dense soil such as clay. The rigidity of this foot piece permits application of substantial force in effecting closure of the bit assembly. Furthermore, this operation of the foot piece for closing the bit assembly greatly reduces the effort required to capture a weed. A further advantage of this rigid foot piece is that it provides support for fulcrum piece 114 during weed extraction. This fulcrum piece 114 provides more surface area than the end of foot piece 116 for extraction of difficult weeds without damage to surrounding turf grass. Moreover, a distance from the handle end 124 of the elongated shaft is preferably at least four times a distance between the bit assembly 118 and the fulcrum piece 114. Thus, a force applied to handle end 124 of the elongated shaft 100 with respect to fulcrum piece 114 will preferably have an advantage of leverage over a loaded bit assembly of at least four. This further advantage minimizes the effort required to extract the weed after it is captured by bit assembly 118. Furthermore, this advantage of leverage substantially eliminates the need for bending or lifting during weed extraction.

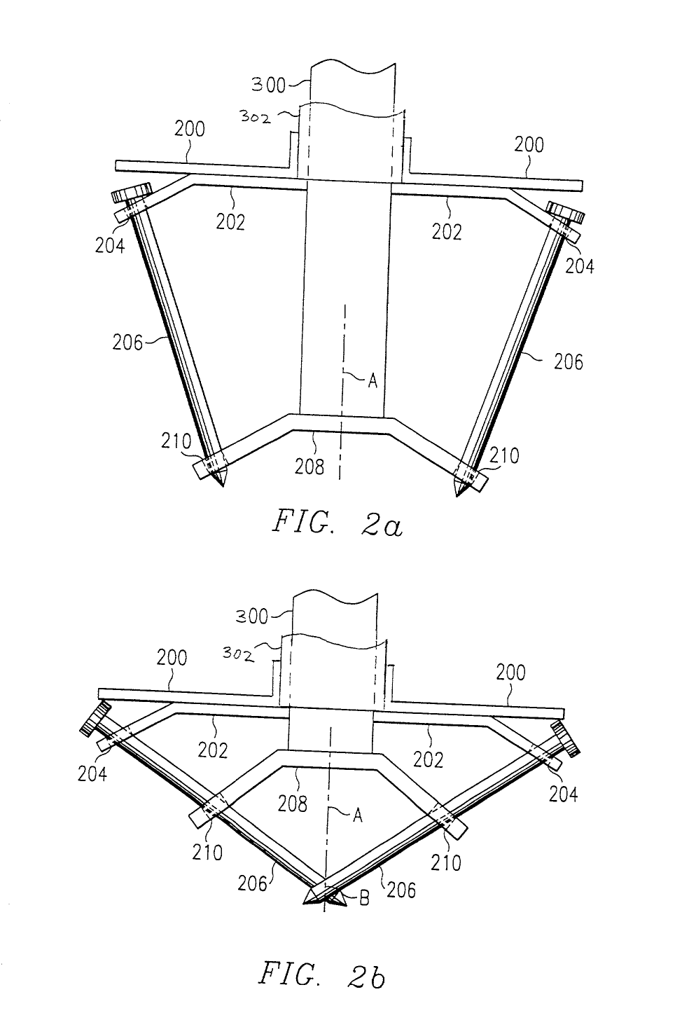

Referring now to FIG. 2A and FIG. 2B, operation of a bit assembly of the instant invention will be explained in detail. The bit assembly of FIG. 2A is in the open position. An upper alignment device 202 is attached to the lower side of extended tabs 200 and to the distal end of the first shaft 302. This upper alignment device 202 includes holes 204 for pivotally connecting one end of opposed spikes 206 to the bit assembly. Preferably the opposed spikes 206 include five parallel spikes 206 in a first set on one side of the bit assembly and five parallel spikes 206 in a second set on the other side of the bit assembly. From the front view, however, only two opposed spikes 206 are visible. A lower alignment device 208 is connected to the distal end of the second shaft 300. This lower alignment device 208 includes holes 210 for guiding the other end of opposed spikes 206 during movement between the open and closed positions. In this open position, elongated shaft 100 is extended to a position below extended tabs 200. Thus, spikes 206 are spaced apart from a plane A that bisects an angle between spikes 206. This angle between the opposed spikes in the open position is less than ninety degrees.

In operation, lower alignment device 208 is placed on top of a weed to be captured. Foot pressure is applied to foot piece 116 (FIG. 3), thereby forcing the first shaft 302, extended tabs 200 and upper alignment device 202 to slide down the second shaft 300 to a position near lower alignment device 208 (FIG. 2B). During this sliding motion, extended tabs 200 and upper alignment device 202 apply a force to upper ends of opposed spikes 206. Opposed spikes 206 slide through holes 210 in response this force. The lower ends of opposed spikes 206 are guided along their respective trajectories to a closed position B. In this closed position B, the lower ends of the opposed spikes 206 intersect a plane A that bisects an angle between the opposed spikes 206. In the closed position, this angle between the opposed spikes is greater than ninety degrees.

This closed position B is highly advantageous for capturing a weed prior to extraction. The spikes do not grasp or pinch the weed. Rather, the spikes enclose the weed from below. Enclosure of the captured weed is completed by opposed spikes 206 passing through the weed root system and forming an angle under the body of the weed that is greater than ninety degrees. This angle permits extraction of the root system and weed body without the need to pinch or otherwise damage the weed. Thus, the weed is not damaged, and subsequent extraction greatly reduces a likelihood of decapitating the weed. Furthermore, the lower ends of opposed spikes 206 intersect plane A forming an interdigitated pattern of opposed spikes 206 below the body of the weed, thereby capturing the weed between opposed spikes 206 and lower alignment device 208 and precluding premature release of the weed. Finally, these interdigitated spikes are closely spaced to support the body of the weed during extraction, thereby reducing a likelihood of tearing the weed into multiple pieces during extraction.

A subsequent return of bit assembly 118 to the open position is effected by application of an upward force on upper alignment device 202 with respect to lower alignment device 208. This upward force retracts spikes 206 through holes 210 to the open position (FIG. 2A). This retraction of spikes 206 through holes 210 advantageously cleans spikes 206. The retraction of spikes 206 also releases the weed, which is then ejected when the bit assembly 118 is returned to the open position.

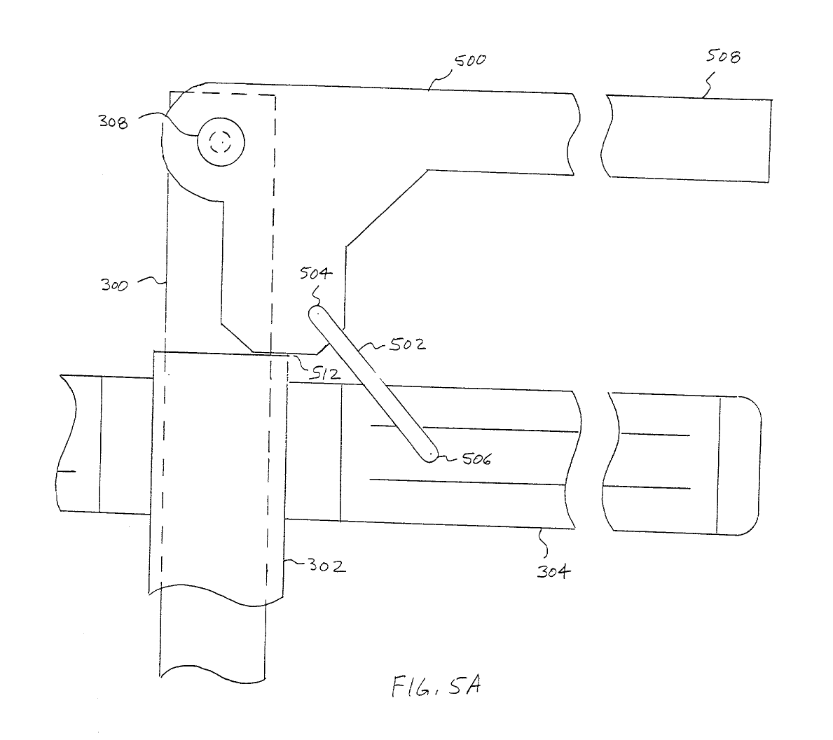

Referring now to FIG. 4A and FIG. 4B, operation of latch piece 306 will be described in detail. The second position (FIG. 4A) of latch piece 306 corresponds to a closed position of bit assembly 118. The second shaft 300 is held in an extended position with respect to the first shaft 302 by latch 306 abutting the first shaft 302 at 312. This extended position holds the lower alignment device 208 near the upper alignment device 202 (FIG. 2) to maintain the bit assembly 118 in the closed position. In a first position of latch 306 (FIG. 4B) the second shaft 300 is free to move within the first shaft 302 along their common axis, thereby permitting the lower alignment device 208 to move away from the upper alignment device 202.

In operation, bit assembly 118 is placed over a weed to be captured with the latch 306 and first 302 and second 300 shafts in the position of FIG. 4B. Pressure is applied to foot piece 116 by a human foot causing the lower alignment device 208 to move near the upper alignment device 202, thereby closing the bit assembly and capturing the weed as previously described. This movement of the lower alignment device 208 with respect to the upper alignment device 202 moves the second shaft 300 to the extended position of FIG. 4A with respect to the first shaft 302. The force of gravity on latch piece 306 causes it to rotate about hinge pin 308 from a first position (FIG. 4B) to a second position (FIG. 4A) to abut the handle end of the first shaft 302 at 312. In this closed and locked position, the first shaft 302 is rotated by handles 304 about fulcrum piece 114 to extract a captured weed.

The latch 306 is highly advantageous in extracting large weeds and other plants with extensive root systems. Latch 306 remains wedged against the handle end of first shaft 302 at 312, thereby maintaining a firmly closed position of bit assembly 118 after the weed is captured. This firmly closed position is necessary to extract mature weeds, such as dallisgrass, which may require more than 80 pounds of vertical force for extraction. This 80 pounds of vertical force for extraction, for example, is achieved through an advantage of leverage of preferably at least four by application of 20 pounds of lateral force at the handle end 124 of elongated shaft 100. This vertical force is applied to bit assembly 118 to extract the captured weed and root system.

The bit assembly may then be positioned over a proper receptacle (not shown) and latch 306 is moved from the second position (FIG. 4A) to the first position (FIG. 4B) by application of thumb pressure on control tab 310. Vertical force may also be applied to latch 306 to move the second shaft 300 into the first shaft 302, thereby releasing the captured weed. Thus, a further advantage of the weed extractor is that the entire procedure of weed capture, extraction and ejection may be completed with little effort while the user remains standing in an upright position. Moreover, movement of only a single latch piece 306 from a first position to a second position locks the bit assembly in the closed position in preparation for weed extraction. No additional springs or control pieces are required. Manufacturing complexity and cost are greatly reduced.

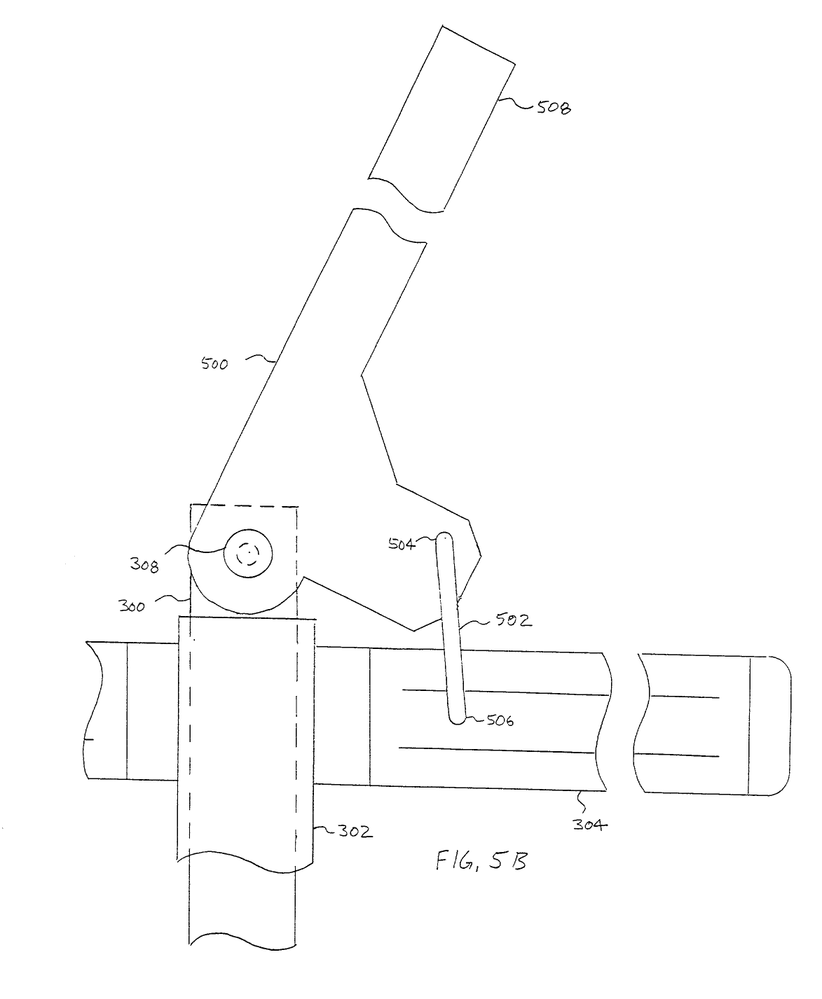

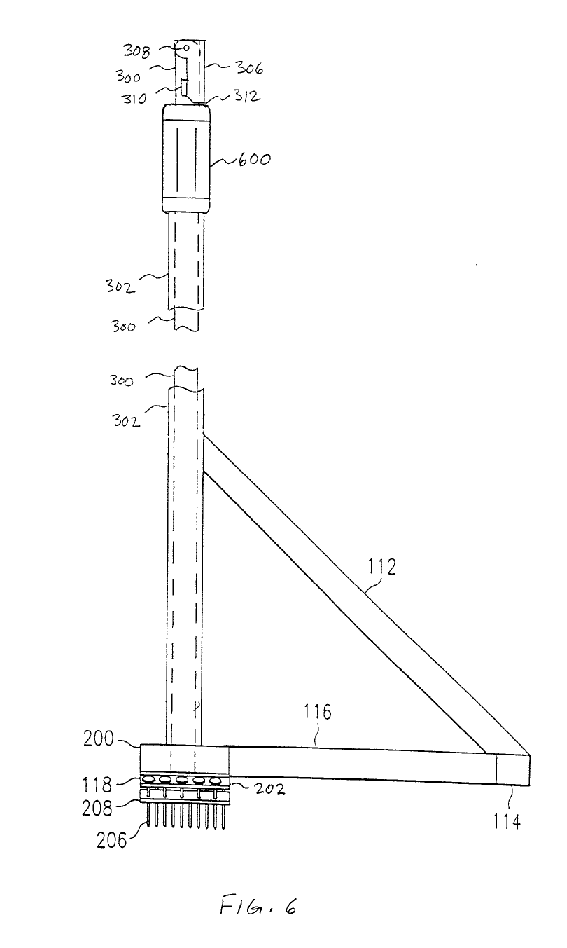

Referring now to FIG. 5A, there is a side view of another embodiment of a weed extractor of the present invention with the bit assembly 118 in the closed position. This closed position corresponds to a closed position of bit assembly 118 after a weed is captured as previously described. Where applicable, reference numerals are consistent with the previously described embodiment. In this embodiment, a combined handle piece 508 and latch piece 500 are pivotally attached by hinge pin 308 to the handle end of second shaft 300. The latch piece 500 is also pivotally attached to handle 304 and first shaft 302 by hinge piece 502. In the second position of FIG. 5A, latch 500 abuts the handle end of first shaft 302 at 512, thereby holding the bit assembly 118 in the closed position.

Turning now to FIG. 5B, there is a side view of the embodiment of FIG. 5A of the present invention with the bit assembly in the open position. In this position, handle 508 is restrained by hinge piece 502. In operation, handle 508 is rotated about hinge pin 308 to a first position. Movement of the handle 508 from the second position to the first position of FIG. 5B causes second shaft 300 to move along the common axis with first shaft 302, thereby forcing the lower alignment device 208 away from the upper alignment device 202. This relative movement of the lower alignment device 208 opens the bit assembly 118, thereby releasing a captured weed.

This embodiment of the present invention offers a further advantage of leverage of handle 508 in moving bit assembly 118 from a closed position to an open position, thereby releasing a captured weed. This advantage of leverage is particularly advantageous after repeated use in clay soil that may tend to inhibit movement of the spikes in the lower alignment device 208.

Although the invention has been described in detail with reference to a preferred embodiment, it is to be understood that this description is by way of example only and is not to be construed in a limiting sense. Many alternative materials might be used to construct a weed extractor of the instant invention. For example, second shaft 300 may be constructed of lightweight material, since lateral movement is constrained under compressive force by first shaft 302. Furthermore, both first and second shafts may have a round cross section. Rotational alignment may then be maintained by an alignment key fixed to one shaft and slidely attached to the other shaft.

Referring to FIG. 6, there is another embodiment of the weed extractor of the present invention. This embodiment is similar to the previously described embodiment of FIG. 3 except that handles 304 are omitted. Handgrip 600 is attached to the handle end of the first shaft 302. Handgrip 600 is preferably formed from a soft, non-slip material to facilitate operation of the weed extractor. Omission of the handles 304 is possible without compromise of operational effectiveness, since the weed extractor employs leverage with respect to fulcrum piece 114 to extract a weed. Thus, extraction does not require vertical force applied to handles 304 as with devices of the prior art. Moreover, this embodiment is compatible with previously described embodiments of FIGS. 4A, 4B, 5A and 5B. For example, hinge piece 502 may be attached at a hole 506 in a small metal tab (not shown) in lieu of handle 304. This further simplification of the weed extractor is highly advantageous as a further simplification and for further weight reduction.

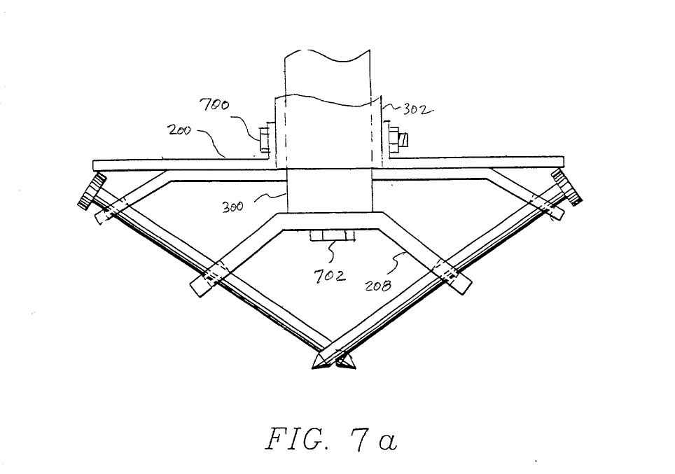

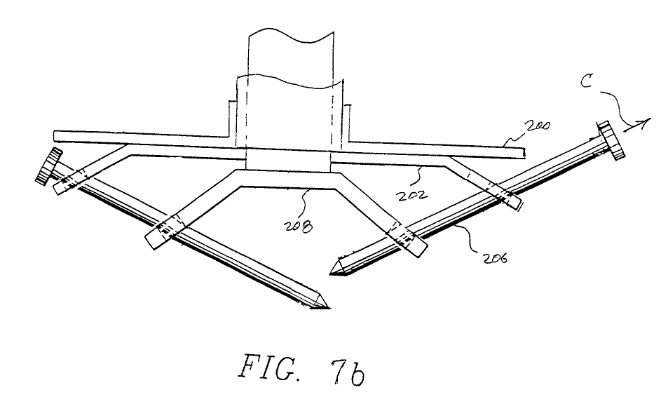

Referring now to FIG. 7A, there is a front view of another embodiment of the weed extractor of the present invention having a removable bit assembly. This removable bit assembly is similar to the previously described bit assembly of FIGS. 2A-2B, except that extended tabs 200 are attached to shaft 302 by bolt 700, and lower alignment device 208 is attached to shaft 300 by bolt 702. This arrangement is highly advantageous, since multiple size bit assemblies may be fitted to the same weed extractor. These multiple size bit assemblies may be selectively utilized for extracting correspondingly different size weeds. A cost of each bit assembly is substantially less than a cost of an entire weed extractor. Thus, this removable bit is cost effective and more efficient in removing different size weeds.

The embodiment of FIG. 7B is a front view of yet another embodiment of the weed extractor of the present invention having removable spikes. This bit assembly is similar to the previously described bit assembly of FIGS. 2A-3, except that individual spikes may be removed from each side of this bit assembly so that it is smaller. Removal of these spikes is readily accomplished by moving lower alignment device 208 to a position near upper alignment device 202. In this position, the head of spike 206 will clear extended tab 200 and may be removed as indicated by arrow C. For example, the bit assembly of FIG. 7B may be adjusted to accommodate small weeds by removing two adjacent spikes from each side of the bit assembly, thereby providing three spikes on each side rather than five on each side as in the embodiment of FIG. 5.

It is to be further understood that numerous changes in the details of the embodiments of the invention will be apparent to persons of ordinary skill in the art having reference to this description. It is contemplated that such changes and additional embodiments are within the spirit and true scope of the invention as claimed below.

What is claimed:

1. An extractor, comprising:
a first shaft having a handle end and a distal end;
a second shaft having a handle end and a distal end;
a bit assembly having an upper alignment device connected to the distal end of the first shaft and having a lower alignment device connected to the distal end of the second shaft; and
a latch connected between the handle end of the first shaft and the handle end of the second shaft, the latch having a first position permitting the bit assembly to move between an open position and a closed position and having a second position arranged to hold the bit assembly in the closed position.

2. An extractor as in claim 1, further comprising a foot piece having a first end attached to the distal end of the first shaft, the foot piece extending perpendicular to an axis of the first shaft.

3. An extractor as in claim 2, further comprising a fulcrum piece attached to a second end of the foot piece.

4. An extractor as in claim 1, wherein the bit assembly comprises a plurality of pivotally mounted opposed spikes, the bit assembly moving between the open position and the closed position in response to movement of the first shaft with respect to the second shaft, wherein at least two opposed spikes are spaced apart from a plane bisecting an angle between the at least two opposed spikes in the open position, and wherein a part of each of the at least two opposed spikes intersects the plane in the closed position.

5. An extractor as in claim 1, wherein the bit assembly comprises two sets of pivotally mounted opposed spikes, each set comprising a plurality of substantially parallel spikes, wherein the sets of spikes are spaced apart from a plane bisecting an angle between the sets in the open position, and wherein a part of each set of spikes intersects the plane in the closed position.

6. An extractor as in claim 5, wherein lower alignment device includes a plurality of holes for guiding each respective spike of the plurality of substantially parallel spikes.

7. An extractor as in claim 5, wherein the two sets form an angle less than ninety degrees in the open position and wherein the angle is greater than ninety degrees in the closed position.

8. An extractor as in claim 1, wherein the first shaft is elongated such that a force applied to the handle end of the first shaft with respect to the second end of the foot piece has an advantage of leverage of at least four over the bit assembly.

9. An extractor as in claim 1, further comprising a handle piece pivotally connected to the handle end of one of the first and second shaft, the handle piece having a first position and a second position; and
a hinge piece having a first end pivotally connected to the latch and having a second end pivotally connected to the handle end of the other of the first and second shaft.

10. An extractor as in claim 1, wherein movement of the handle piece from the first position to the second position closes the bit assembly for capturing a weed, and wherein movement of the handle piece from the second position to the first position opens the bit assembly for ejecting the weed.

11. An extractor as in claim 1, wherein pressure of a foot on the foot piece closes the bit assembly, thereby capturing a weed.

12. An extractor as in claim 1, wherein the latch piece further comprises a control piece arranged to facilitate movement of the latch piece between the first and second positions.

13. A method of extracting a plant, comprising the steps of:
placing a bit assembly over the plant;
moving one shaft with respect to another shaft, thereby enclosing the plant in the bit assembly;
moving a latch coupled between ends of the shafts opposite the bit assembly from a first position to a second position, thereby fixing the position of the one shaft with respect to the another shaft; and
exerting a force on the bit assembly, thereby extracting the plant.

14. A method as in claim 13, further comprising the steps of:
moving the latch from the second position to the first position, thereby releasing the one shaft with respect to the another shaft; and
moving the one shaft with respect to the another shaft, thereby releasing the plant in the bit assembly.

15. An extractor, comprising:
a first shaft having a handle end and a distal end; and
a bit assembly connected to the distal end of the first shaft, the bit assembly having a variable size.

16. An extractor as in claim 15, wherein the variable size comprises at least two bit assemblies of different sizes arranged to connect to the distal end of the first shaft.

17. An extractor as in claim 15, wherein the variable size comprises a bit assembly having removable spikes.

18. An extractor as in claim 15, comprising a second shaft having a handle end and a distal end, the bit assembly having an upper alignment device connected to the distal end of the first shaft and having a lower alignment device connected to the distal end of the second shaft.

19. An extractor as in claim 18, comprising a latch connected between the handle end of the first shaft and the handle end of the second shaft, the latch having a first position permitting the bit assembly to move between an open position and a closed position and having a second position arranged to hold the bit assembly in the closed position.

20. An extractor as in claim 18, wherein the bit assembly comprises a plurality of pivotally mounted opposed spikes, the bit assembly moving between an open position and a closed position in response to movement of the first shaft with respect to the second shaft, wherein at least two opposed spikes are spaced apart from a plane bisecting an angle between the at least two opposed spikes in the open position, and wherein a part of each of the at least two opposed spikes intersects the plane in the closed position.
